(19) United States
(12) Patent Application Publication
(10) Pub. No.: US 2020/0101846 A1
(43) Pub. Date: Apr. 2, 2020

(54) OPERATION INPUT APPARATUS

(71) Applicant: HONDA MOTOR CO., LTD., Tokyo (JP)

(72) Inventor: Ryohei KAMADA, Wako-shi (JP)

(21) Appl. No.: 16/565,871

(22) Filed: Sep. 10, 2019

(30) Foreign Application Priority Data
Sep. 28, 2018 (JP) 2018-184938

(51) Int. Cl. B60K 37/06; G06F 3/041; G06F 3/02; G06F 3/14; G06F 3/16

(52) U.S. Cl. CPC B60K 37/06; G06F 3/041; G06F 3/02; B60K 2370/65; G06F 3/165; B60K 2370/1438; B60K 2370/126; G06F 3/1423

(57) ABSTRACT

An operation input apparatus for a vehicle, comprising: a touch panel display that extends in a vehicle width direction; an instrument panel that has a flat surface that extends from a position near a lower end of the touch panel display, in a rearward direction of the vehicle; and an operation input unit that is provided in the flat surface, wherein the operation input unit includes one or more button switches, and upper surfaces of the one or more button switches are flush with the flat surface, or are located on a lower side of the vehicle relative to the flat surface.

### CROSS-REFERENCE TO RELATED APPLICATION(S)

This application claims priority to and the benefit of Japanese Patent Application No. 2018-184938 filed on Sep. 28, 2018, the entire disclosure of which is incorporated herein by reference.

### BACKGROUND OF THE INVENTION

### Field of the Invention

The present invention relates to an operation input apparatus for a vehicle.

### Description of the Related Art

Japanese Patent Laid-Open No. 2008-129689 discloses a structure that is provided with an armrest and an armrest switch to improve the operability of a touch panel.

However, the technology disclosed in Japanese Patent Laid-Open No. 2008-129689 requires components such as an armrest and an armrest switch, and if the touch panel display is enlarged, the distance between the armrest and the screen increases, which degrades operability. Also, the armrest needs to be enlarged in order to keep operability at the same level, and thus there is the problem that costs increase and the aesthetic quality is degraded.

The present invention has been made in view of such a problem, and provides an operation input apparatus with high operability and high aesthetic quality at low cost, even if the touch panel display has a large screen.

### SUMMARY OF THE INVENTION

According to one aspect of the present invention, there is provides an operation input apparatus for a vehicle, comprising: a touch panel display that extends in a vehicle width direction; an instrument panel that has a flat surface that extends from a position near a lower end of the touch panel display, in a rearward direction of the vehicle; and an operation input unit that is provided in the flat surface, wherein the operation input unit includes one or more button switches, and upper surfaces of the one or more button switches are flush with the flat surface, or are located on a lower side of the vehicle relative to the flat surface.

### BRIEF DESCRIPTION OF THE DRAWINGS

FIG. 1 is an external view of an operation input apparatus according to an embodiment of the present invention.

FIG. 2 illustrates operations that are performed on the operation input apparatus according to the embodiment of the present invention.

FIG. 3 is a diagram showing an example of a configuration of an operation input unit according to the embodiment of the present invention.

FIG. 4 is a diagram showing an example of a garnish of the operation input unit according to the embodiment of the present invention.

FIG. 5 is a diagram showing attachment parts inside the operation input unit according to the embodiment of the present invention seen from below a vehicle.

### DESCRIPTION OF THE EMBODIMENTS

The following describes an embodiment of the present invention with reference to the drawings. Note that same constituent elements in the drawings are assigned the same reference numerals. Also, the words “TOP”, “BOTTOM”, “FRONT”, “REAR”, “LEFT”, and “RIGHT” respectively indicate an upward direction, a downward direction, a forward direction, a rearward direction, a direction to the left, and a direction to the right, relative to the vehicle body.

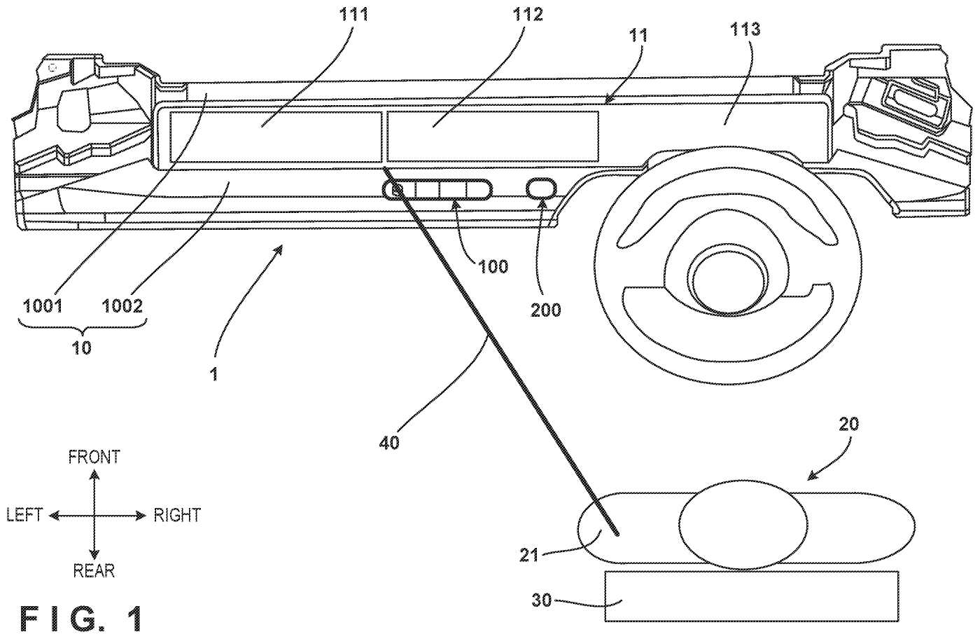

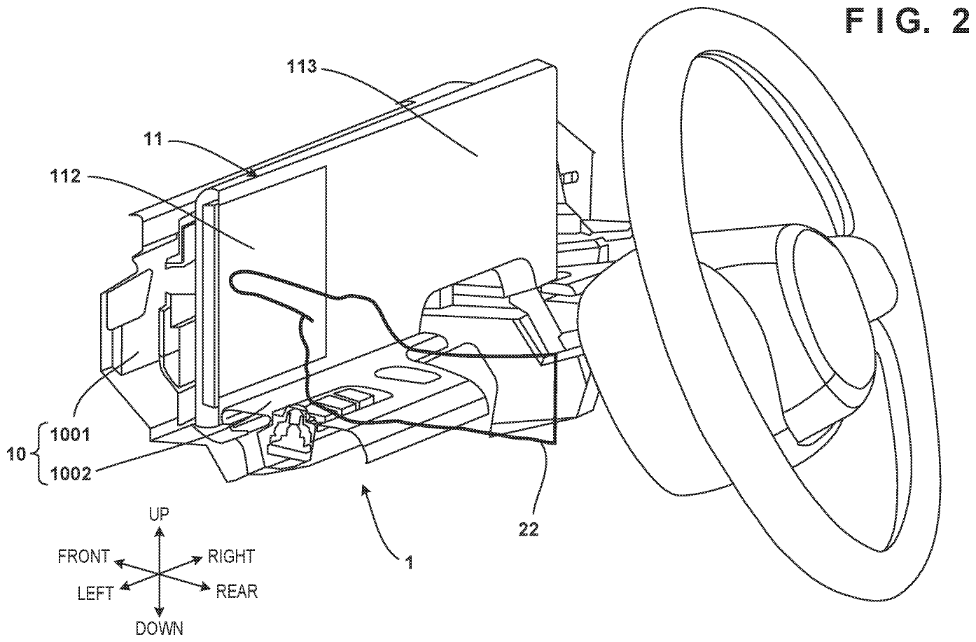

First, a configuration of an operation input apparatus according to an embodiment of the present invention will be described with reference to FIGS. 1 and 2. FIG. 1 is an external view of an operation input apparatus according to an embodiment of the present invention. FIG. 2 illustrates operations that are performed on the operation input apparatus according to the embodiment of the present invention.

In FIGS. 1 and 2, the reference numeral 1 indicates an operation input apparatus for a vehicle. A vehicle according to the present embodiment is a vehicle that is provided with the operation input apparatus 1. The reference numeral 10 indicates an instrument panel that is made of resin, and the reference numeral 11 indicates a touch panel display that extends in the vehicle width direction. In the present embodiment, the instrument panel 10 includes an instrument panel upper portion 1001 and an instrument panel lower portion 1002. However, the instrument panel 10 is not necessarily constituted by a plurality of members, and may be constituted by a single member. Also, the instrument panel upper portion 1001 and the instrument panel lower portion 1002 may each be referred to as an instrument panel. In the present embodiment, the touch panel display 11 includes a plurality of touch panel displays 111 and 112 and an indicator 113. The instrument panel lower portion 1002 has a flat surface that extends from a position near the lower end of the touch panel display 11, in a rearward direction of the vehicle. In this way, the flat surface of the instrument panel 10 extends from a position near the lower end thereof, along a plurality of touch panel displays (the touch panel displays 111 and 112 in the example shown in the drawings), in a rearward direction of the vehicle. The operation input apparatus 1 includes the instrument panel 10 (specifically the instrument panel lower portion 1002) and the touch panel display 11.

The reference numeral 20 indicates an occupant, the reference numeral 21 indicates a shoulder of the occupant 20, and the reference numeral 22 indicates a hand of the occupant 20. The reference numeral 30 indicates the backrest of the seat on which the occupant 20 sits. The reference numeral 40 indicates a straight line that connects the shoulder of the occupant 20 and the boundary between the touch panel displays.

The reference numeral 100 indicates an operation input unit that is provided in the flat surface of the instrument panel lower portion 1002. The operation unit 100 is located such that at least a portion of the operation unit 100 intersects the straight line 40. The operation input apparatus 1 may also include the operation unit 100.

The occupant 20 can operate various devices in the vehicle such as the touch panel display 11 and an audio device (not shown) by operating the operation unit 100. Also, the operation unit 100 is provided on the straight line 40, and therefore the operation unit 100 is present within the range of movement of an arm of the occupant 20. Thus, operability is improved.

The reference numeral 200 indicates an automatic parking switch for automatic parking. Although the automatic parking switch 200 is located apart from the operation input unit 100 in the example shown in the drawings, the automatic parking switch 200 may be integrated with the operation input unit 100.

In this way, the operation input apparatus 1 includes the instrument panel 10 (specifically the instrument panel lower portion 1002) that has a flat surface and the touch panel display 11, and therefore the occupant 20 can put his/her hand 22 on the flat surface of the instrument panel lower portion 1002 to operate the touch panel display 11. Therefore, the position of the hand can be stable, and the occupant is unlikely to get tired while operating the touch panel display 11. Also, it is possible to prevent incorrect operation of the touch panel display 11. Also, it is only necessary that the instrument panel lower portion 1002 is provided with a flat surface. Therefore, even in a case of a touch panel display with a large screen, it is possible to provide an operation input apparatus with excellent operability and aesthetic quality at low cost.

In addition, the operation input unit 100 is provided in the flat surface of the instrument panel lower portion 1002. Therefore, it is easier to operate the touch panel display 11 by directly touching it, and it is also easier to operate the operation input unit 100. Thus, operability can be further improved.

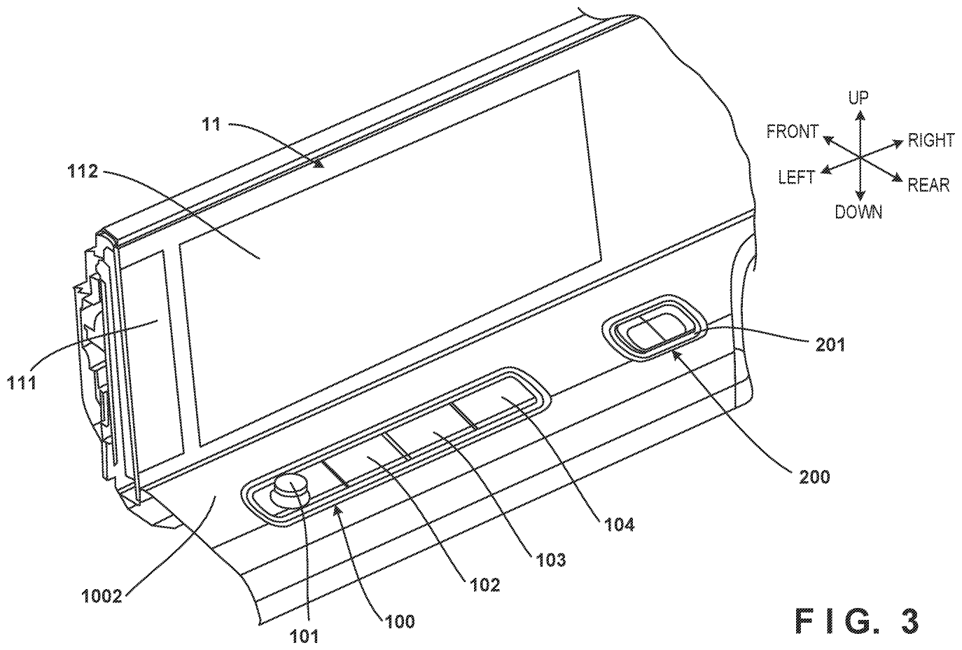

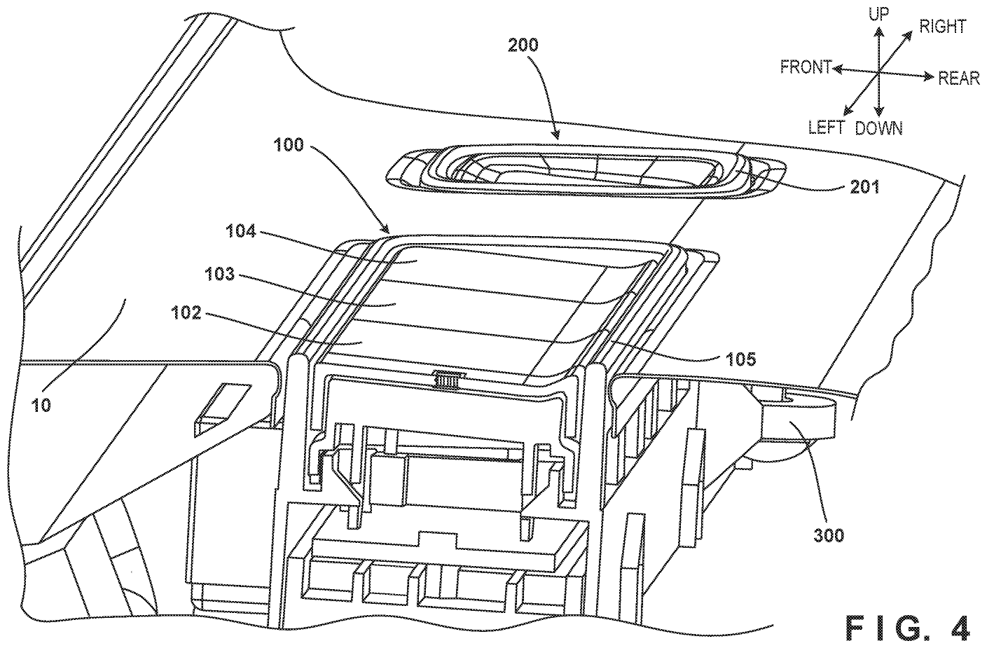

Next, the details of a configuration of the operation input unit 100 according to the embodiment of the present invention will be described with reference to FIGS. 3 and 4. FIG. 3 is a diagram showing an example of a configuration of the operation input unit according to the embodiment of the present invention. FIG. 4 is a diagram showing an example of a garnish of the operation input unit according to the embodiment of the present invention.

In FIGS. 3 and 4, the reference number 101 indicates a rotary knob for adjusting the volume of an audio device (not shown). The reference numeral 102 indicates a mute button switch for muting the audio device (not shown). The reference numeral 103 indicates a brightness adjustment button switch for adjusting the brightness of the touch panel display 11. The reference numeral 104 indicates a home button switch for returning the screen of the touch panel display 11 to a predetermined screen (a home screen).

The operation input unit 100 includes the rotary knob 101, the mute button switch 102, the brightness adjustment button switch 103, and the home button switch 104. The respective upper surfaces of the mute button switch 102, the brightness adjustment button switch 103, and the home button switch 104 are flush with the flat surface of the instrument panel lower portion 1002, or are located on the lower side of the vehicle relative to the flat surface.

The number of button switches is not particularly limited. The operation input unit 100 need only include one or more button switches such that the respective upper surfaces of the one or more button switches are flush with the flat surface or are located on the lower side of the vehicle relative to the flat surface. The one or more button switches include a button switch (the brightness adjustment button switch 103 and the home button switch 104 in the present embodiment) for controlling the content that is displayed on the touch panel display 11.

It is possible to improve usability by providing the button switches for controlling the content that is displayed, near the touch panel display. Also, there is no need to provide a button switch on the surface of the touch panel display, and therefore it is possible to enlarge the screen of the touch panel display.

Also, it is possible to save space by providing the button switches on the flat surface of the instrument panel lower. Furthermore, by employing a configuration in which the respective upper surfaces of the button switches are flush with the flat surface or are located on the lower side of the vehicle relative to the flat surface, it is possible to prevent accidental pressing of the button switches when the occupant puts his/her hand on the flat surface to operate the touch panel display. Therefore, it is possible to prevent incorrect operation of the button switches of the operation input unit.

The rotary knob 101 is provided at a position near a boundary between a plurality of touch panel displays included in the touch panel display 11 (in the example shown in the drawings, a position near the lower end of the boundary between the touch panel display 111 and the touch panel display 112 on the flat surface of the instrument panel lower portion 1002). In this way, the knob, which is a protrusion, is provided near an end of the display, and therefore the knob does not interfere with a touch operation through which the touch panel display 11 is directly touched, and incorrect operation of the knob 101, which is used to adjust the volume of the audio device (not shown), is prevented.

The mute button switch 102 is provided adjacent to the rotary knob 101. By providing the buttons and the knob related to the volume of the audio device adjacent to each other in this way, it is possible to improve usability.

The reference numeral 105 indicates a garnish that is provided around the button switches of the operation input unit 100. The garnish 105 protrudes in an upward direction of the vehicle relative to the upper surfaces of the button switches. The garnish 105 according to the present embodiment is formed so as to surround the rotary knob 101, the mute button switch 102, the brightness adjustment button switch 103, and the home button switch 104 provided in the operation input unit 100. However, at least the rotary knob 101 need not be surrounded by the garnish 105, and the garnish 105 need only be formed so as to surround the button switches. By surrounding the button switches with the garnish 105 that protrudes in an upward direction of the vehicle in this way, it is possible to prevent incorrect operation of the button switches.

The reference numeral 201 indicates a garnish that is provided around the automatic parking switch 200. The garnish 201 protrudes in an upward direction of the vehicle, as with the garnish 105. By providing the garnish 201, it is possible to protect the automatic parking switch 200 with which a key device or the like for the vehicle may come into contact.

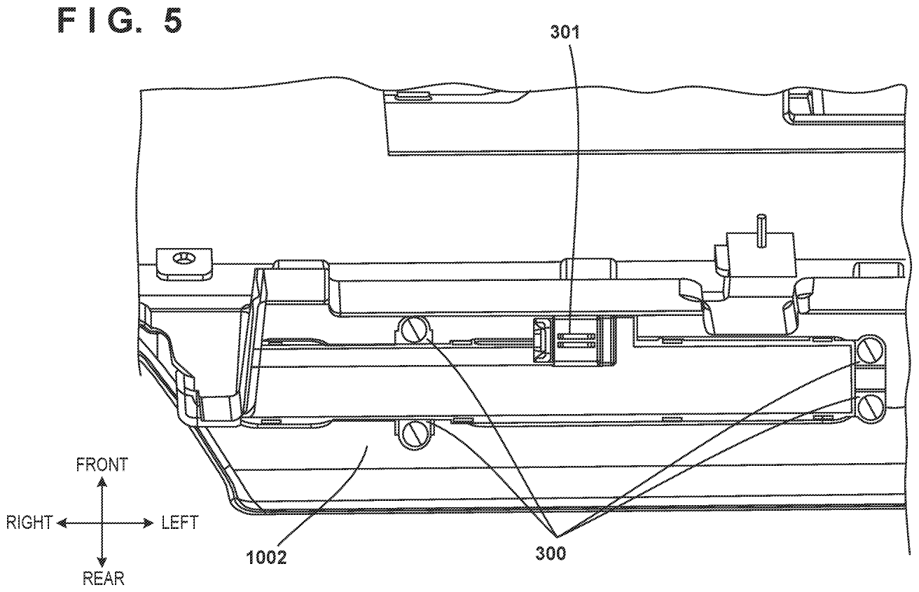

FIG. 5 is a diagram showing attachment parts inside the operation input unit according to the embodiment of the present invention seen from below the vehicle. The reference numerals 300 indicate attachment parts for attaching the operation input unit 100 to the instrument panel 10. The attachment parts 300 are a plurality of members that protrude from the operation input unit 100, and each member has an opening. A fixing member such as a screw is inserted into the opening and is fixed to the instrument panel 10, and thus the operation input unit 100 is attached to the instrument panel 10. The operation input unit 100 also includes a connector 301. The connector 301 and a power supply (not shown) are connected to each other using a harness (not shown). Thus, it is possible to operate the touch panel display 11 by operating the operation input unit 100.

In this way, the operation input unit 100, in which the rotary knob 101, the mute button switch 102, the brightness adjustment button switch 103, the home button switch 104, and the garnish 105 that surround these elements are formed integrally with each other, is attached to the instrument panel 10. Integrating the elements with each other makes it easier to perform attachment work.

Note that the above-described embodiment is an example of means according to the present invention, and the present invention can be applied by altering or modifying the embodiment without departing from the spirit of the present invention.

### Summary of Embodiment

1. The operation input apparatus (e.g. 1) according to the above-described embodiment is

an operation input apparatus (e.g. 1) for a vehicle, including:

a touch panel display (e.g. 11) that extends in a vehicle width direction (e.g. 11);

an instrument panel (e.g. 10, 1002) that has a flat surface that extends from a position near a lower end of the touch panel display, in a rearward direction of the vehicle; and

an operation input unit (e.g. 100) that is provided in the flat surface.

The operation input unit includes one or more button switches (e.g. 102, 103, 104), and

upper surfaces of the one or more button switches are flush with the flat surface, or are located on the lower side of the vehicle relative to the flat surface.

According to this embodiment, an occupant can put his/her hand on the flat surface of the instrument panel lower to operate the touch panel display. Therefore, the position of the hand can be stable, and the occupant is unlikely to get tired while operating the touch panel display. Also, it is possible to prevent incorrect operation of the touch panel display. Also, according to this embodiment, it is possible to prevent accidental pressing of the button switches when the occupant puts his/her hand on the flat surface to operate the touch panel display. Therefore, it is possible to prevent incorrect operation of the button switches of the operation input unit. As described above, it is unnecessary to provide an armrest, and it is only necessary to provide the instrument panel with a flat surface, and to provide the operation input unit on the flat surface. Thus, even in a case of a touch panel display with a large screen, it is possible to provide an operation input apparatus with excellent operability and aesthetic quality at low cost.
2In the operation input apparatus (e.g. 1) according to the above-described embodiment,

the one or more button switches include a button switch (e.g. 103, 104) for controlling content that is displayed on the touch panel display.

According to this embodiment, it is possible to improve usability by providing a button switch for controlling the content that is displayed, near the touch panel display. Also, there is no need to provide a button switch on the surface of the touch panel display, and therefore it is possible to enlarge the screen of the touch panel display.
3The operation input apparatus (e.g. 1) according to the above-described embodiment further includes

a garnish (e.g. 105) that is provided around the one or more button switches (e.g. 102, 103, 104), and

the garnish protrudes in an upward direction of the vehicle relative to upper surfaces of the one or more button switches.

According to this embodiment, by surrounding the button switches with the garnish that protrudes in an upward direction of the vehicle, it is possible to prevent incorrect operation of the button switches.
4. In the operation input apparatus (e.g. 1) according to the above-described embodiment,

the operation input unit (e.g. 100) includes a rotary knob (e.g. 101) for adjusting volume of an audio device,

the touch panel display (e.g. 11) includes a plurality of touch panel displays (e.g. 111, 112), and

the knob is provided near a boundary between the plurality of touch panel displays (e.g. 111, 112).

According to this embodiment, the knob, which is a protrusion, is provided near an end of the display, and therefore the knob does not interfere with a touch operation through which the touch panel display is directly touched, and incorrect operation of the knob, which is used to adjust the volume of the audio device, is prevented.
5. In the operation input apparatus (e.g. 1) according to the above-described embodiment,

the one or more button switches (e.g. 102, 103, 104) include a mute button switch (e.g. 102) for muting the audio device, and

the mute button switch is provided adjacent to the knob (e.g. 101).

According to this embodiment, it is possible to improve usability by providing the button and the knob related to the volume of the audio device adjacent to each other.
6. In the operation input apparatus (e.g. 1) according to the above-described embodiment,

the operation input unit (e.g. 100) includes a rotary knob (e.g. 101) for adjusting volume of an audio device,

the operation input apparatus further includes a garnish (e.g. 105) that is provided around the one or more button switches (e.g. 102, 103, 104) and the knob (e.g. 101), and

the operation input unit is provided with an attachment part (e.g. 300) that is attachable to the instrument panel (e.g. 10, 1002).

According to this embodiment, the knob, the various button switches, and the garnish that surrounds them can be integrally attached to the instrument panel, and therefore attachment work is made easier to perform.
7. In the operation input apparatus (e.g. 1) according to the above-described embodiment,

the touch panel display (e.g. 11) includes a plurality of touch panel displays (e.g. 111, 112), and

the flat surface extends from a position near a lower end of the touch panel display, along the plurality of touch panel displays (e.g. 111, 112), in a rearward direction of the vehicle.

According to this embodiment, it is possible to provide the plurality of touch panel displays with a shared flat surface. Therefore, it is possible to reduce the number of parts, and improve aesthetic quality.

According to the present invention, an occupant can put his/her hand on the flat surface that extends from a position near the lower end of the touch panel display, along the plurality of touch panel displays, in a rearward direction of the vehicle. Also, the button switches are flush with the flat surface, or are located on the lower side of the vehicle relative to the flat surface. Therefore, it is possible to prevent accidental pressing of the button switches when the occupant puts his/her hand on the flat surface to operate the touch panel display. Therefore, it is possible to prevent incorrect operation of the button switches of the operation input unit. As described above, according to the present invention that does not require an armrest, it is possible to provide an operation input apparatus with excellent operability and aesthetic quality at low cost, even in a case of a touch panel display with a large screen.

What is claimed is:

1. An operation input apparatus for a vehicle, comprising:
a touch panel display that extends in a vehicle width direction;
an instrument panel that has a flat surface that extends from a position near a lower end of the touch panel display, in a rearward direction of the vehicle; and
an operation input unit that is provided in the flat surface,
wherein the operation input unit includes one or more button switches, and
upper surfaces of the one or more button switches are flush with the flat surface, or are located on a lower side of the vehicle relative to the flat surface.

2. The operation input apparatus according to claim 1,
wherein the one or more button switches include a button switch for controlling content that is displayed on the touch panel display.

3. The operation input apparatus according to claim 1, further comprising
a garnish that is provided around the one or more button switches,
wherein the garnish protrudes in an upward direction of the vehicle relative to upper surfaces of the one or more button switches.

4. The operation input apparatus according to claim 1,
wherein the operation input unit includes a rotary knob for adjusting volume of an audio device,
the touch panel display includes a plurality of touch panel displays, and
the knob is provided near a boundary between the plurality of touch panel displays.

5. The operation input apparatus according to claim 4,
wherein the one or more button switches include a mute button switch for muting the audio device, and
the mute button switch is provided adjacent to the knob.

6. The operation input apparatus according to claim 1,
wherein the operation input unit includes a rotary knob for adjusting volume of an audio device,
the operation input apparatus further comprises a garnish that is provided around the one or more button switches and the knob, and
the operation input unit is provided with an attachment part that is attachable to the instrument panel.

7. The operation input apparatus according to claim 1,
wherein the touch panel display includes a plurality of touch panel displays, and
the flat surface extends from a position near a lower end of the touch panel display, along the plurality of touch panel displays, in a rearward direction of the vehicle.
